(19) United States
(12) Patent Application Publication
(10) Pub. No.: US 2013/0223899 A1
(43) Pub. Date: Aug. 29, 2013

(54) RECORDING-MEDIUM TRANSPORTING BODY, TRANSFER DEVICE, AND IMAGE FORMING APPARATUS

(71) Applicant: FUJI XEROX CO., LTD., (US)

(72) Inventors: Wataru SUZUKI, Kanagawa (JP); Atsuyuki KITAMURA, Kanagawa (JP); Masahiro SATO, Kanagawa (JP); Tetsuji OKAMOTO, Kanagawa (JP); Koichi WATANABE, Kanagawa (JP); Atsushi OGIHARA, Kanagawa (JP); Shuichi NISHIDE, Kanagawa (JP)

(73) Assignee: FUJI XEROX CO., LTD., Tokyo (JP)

(21) Appl. No.: 13/660,557

(22) Filed: Oct. 25, 2012

(30) Foreign Application Priority Data
Feb. 24, 2012 (JP) 2012-039176

(51) Int. Cl. G03G 15/01

(52) U.S. Cl. 399/304

(57) ABSTRACT

A recording-medium transporting body includes a cylindrical portion, a contact unit, and a holding portion. The cylindrical portion has a cut portion in an outer peripheral surface thereof and allows a recording medium to be wrapped around the outer peripheral surface. The contact unit is provided in the cut portion and includes first and second contact portions having first and second coefficients of friction with respect to the recording medium, the second coefficient of friction being higher than the first coefficient of friction. A leading end of the recording medium comes into contact with the first contact portion before coming into contact with the second contact portion. The holding portion holds the recording medium between the contact unit and the holding portion.

### CROSS-REFERENCE TO RELATED APPLICATIONS

This application is based on and claims priority under 35 USC 119 from Japanese Patent Application No. 2012-039176 filed Feb. 24, 2012.

### BACKGROUND

The present invention relates to a recording-medium transporting body, a transfer device, and an image forming apparatus.

### SUMMARY

According to an aspect of the invention, there is provided a recording-medium transporting body including a cylindrical portion, a contact unit, and a holding portion. The cylindrical portion has a cut portion in an outer peripheral surface thereof and allows a recording medium to be wrapped around the outer peripheral surface. The contact unit is provided in the cut portion and includes a first contact portion having a first coefficient of friction with respect to the recording medium and a second contact portion having a second coefficient of friction with respect to the recording medium, the second coefficient of friction being higher than the first coefficient of friction. A leading end of the recording medium comes into contact with the first contact portion before coming into contact with the second contact portion. The holding portion holds the recording medium between the contact unit and the holding portion.

### BRIEF DESCRIPTION OF THE DRAWINGS

Exemplary embodiments of the present invention will be described in detail based on the following figures, wherein:

FIG. 1 illustrates the overall structure of an image forming apparatus according to a first exemplary embodiment of the present invention;

FIG. 2A illustrates a leading-end gripper and a trailing-end gripper in a plan view of the transfer drum according to the first exemplary embodiment of the present invention;

FIG. 2B illustrates the transfer drum according to the first exemplary embodiment of the present invention viewed in an axial direction;

FIGS. 3A and 3B illustrate the trailing-end gripper according to the first exemplary embodiment of the present invention in an open state and a closed state, respectively;

FIGS. 4A, 4B, 4C, and 4D illustrate a transporting operation in which a sheet of recording paper is transported by the transfer drum according to the first exemplary embodiment of the present invention;

FIG. 5A is a perspective view of a part of a contact unit according to a first exemplary embodiment of the present invention;

FIG. 5B is a perspective view of a modification of the contact unit according to the first exemplary embodiment of the present invention;

FIG. 6 is a schematic diagram illustrating the relationship between the widths of areas in which first and second contact portions are arranged and widths of sheets of recording paper according to the first exemplary embodiment of the present invention;

FIGS. 7A, 7B, and 7C are diagrams illustrating the manner in which a sheet of recording paper is inserted between the leading-end gripper and the contact unit and held when viewed in an axial direction according to the first exemplary embodiment of the present invention;

FIGS. 8A, 8B, and 8C are diagrams illustrating the manner in which the sheet of recording paper is inserted between the leading-end gripper and the contact unit and held when viewed in a transporting direction according to the first exemplary embodiment of the present invention;

FIG. 9 is a perspective view of a leading-end gripper and a contact unit according to a second exemplary embodiment of the present invention;

FIGS. 10A, 10B, and 10C are diagrams illustrating the manner in which a sheet of recording paper is inserted between the leading-end gripper and the contact unit and held when viewed in a transporting direction according to a second exemplary embodiment of the present invention; and

FIG. 11 is a diagram illustrating a leading-end gripper and a contact unit according to a comparative example.

### DETAILED DESCRIPTION

### First Exemplary Embodiment

A recording-medium transporting body, a transfer device, and an image forming apparatus according to a first exemplary embodiment of the present invention will now be described.

### Overall Structure

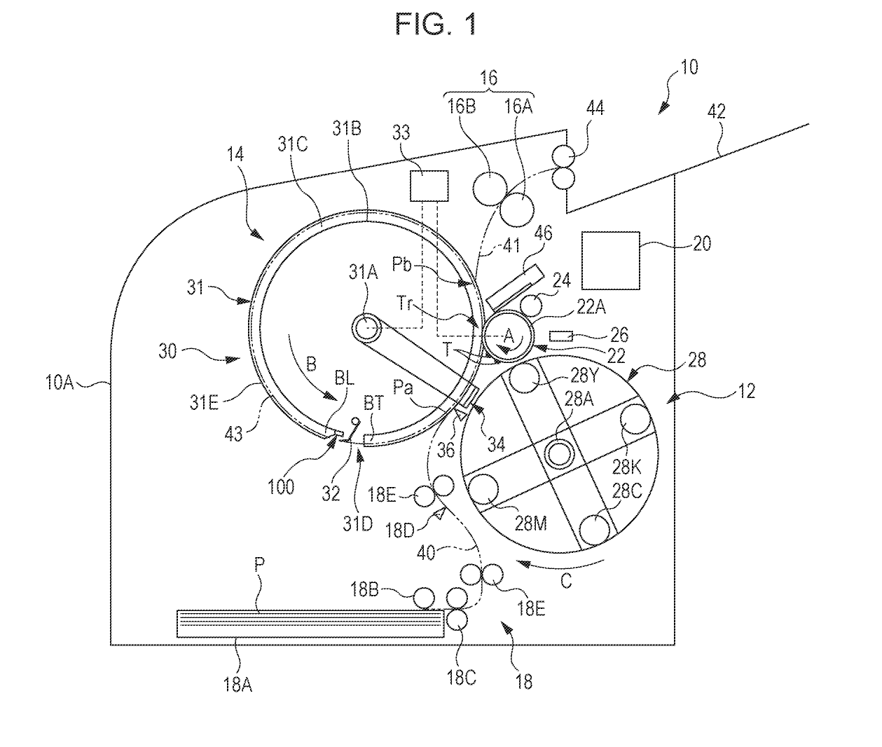

FIG. 1 illustrates an image forming apparatus 10 according to the first exemplary embodiment of the present invention. The image forming apparatus 10 includes an image forming unit 12, a paper feed unit 18, a transfer device 14, a fixing device 16, and a controller 20. The image forming unit 12 forms a toner image T, which is an example of a developer image. The paper feed unit 18 feeds and transports a sheet of recording paper P, which is an example of a recording medium. The transfer device 14 transfers the toner image T formed by the image forming unit 12 onto the sheet of recording paper P while retaining the sheet of recording paper P. The fixing device 16 fixes the toner image T to the sheet of recording paper P after the sheet of recording paper P is released from the transfer device 14. The controller 20 controls the overall operation (operation of each part) of the image forming apparatus 10. A housing 10A that serves as an apparatus body houses components of the image forming apparatus 10. A paper receiver 42, which receives the sheet of recording paper P that has been ejected from the fixing device 16, is provided at the top of the housing 10A.

The image forming unit 12 includes the photoconductor drum 22, a charging device 24, an exposure device 26, a developing device 28, and a cleaning device 46. The photoconductor drum 22 is an example of an image carrier, and is rotatable. The charging device 24 charges the photoconductor drum 22. The exposure device 26 subjects the photoconductor drum 22 in the charged state to an exposure process. The developing device 28 is an example of a developer-image forming unit and performs a developing process by using toner (not shown), which is an example of developer. The cleaning device 46 removes the toner that remains on the photoconductor drum 22 after a transfer process from the photoconductor drum 22.

The photoconductor drum 22 includes a photosensitive layer 22A having, for example, a negative charge polarity, on the outer peripheral surface thereof. The photoconductor drum 22 may be rotated in the direction of arrow A (clockwise in FIG. 1) by a driving unit (not shown) including a motor. The outer diameter of the photoconductor drum 22 is, fore example, 30 mm. The photoconductor drum 22 is grounded. The charging device 24, the exposure device 26, the developing device 28, and the cleaning device 46 are arranged so as to face the photosensitive layer 22A (outer peripheral surface) of the photoconductor drum 22 in that order in the direction of arrow A.

The charging device 24 is, for example, a contact roller discharge device, and discharges electricity when a voltage is applied to the charging device 24 by a voltage applying unit (not shown) and a potential difference is generated between the charging device 24 and the photoconductor drum 22, which is grounded. The charging device 24 charges the photoconductor drum 22 while rotating together with the photoconductor drum 22.

The exposure device 26 forms an electrostatic latent image by irradiating the charged surface of the photoconductor drum 22 with light on the basis of image information. The exposure device 26 includes, for example, an array of LEDs (not shown), which serve as light sources, and distributed index lenses.

The developing device 28 is a rotary developing device that has a columnar shape. The developing device 28 includes a rotating shaft 28A, whose axial direction coincides with that of a rotating shaft (not shown) of the photoconductor drum 22, and yellow (Y), magenta (M), cyan (C), and black (K) developing units 28Y, 28M, 28C, and 28K which are arranged around the rotating shaft 28A at an angular pitch of 90°. The developing device 28 is detachably attached to the housing 10A. The developing device 28 is configured to rotate around the rotating shaft 28A in the direction of arrow C (clockwise in FIG. 1).

In the case where only single-color images are to be formed instead of color images (multicolor images), the developing device 28 may be replaced by a developing device that includes only a developing unit for a single color (for example, only the black (K) developing unit 28K). The developing device 28 is configured such that one of the developing units 28Y, 28M, 28C, and 28K is stopped at the position where the developing device 28 faces the outer peripheral surface of the photoconductor drum 22. Thus, the developing device 28 develops the electrostatic latent image that has been formed on the photoconductor drum 22 by the exposure device 26 with toner. The outer diameter of the developing device 28 is, for example, 100 mm.

Each of the developing units 28Y, 28M, 28C, and 28K contains, for example, single-component developer (not shown) which includes only magnetic or non-magnetic toner. Although the single-component developer is used as an example in the present exemplary embodiment, two-component toner including toner and carrier may instead be used. In the following description, the single-component developer is simply referred to as developer.

The cleaning device 46 includes, for example, a blade-type cleaner and removes with a blade the developer and substances other than the developer that remain on the outer peripheral surface of the photoconductor drum 22 after the transfer process.

A feed path 40 and an output path 41 are provided in the housing 10A. The feed path 40 is provided for transporting a sheet of recording paper P from a paper container 18A, which will be described below, to a transfer region Tr. The output path 41 is used to eject the sheet of recording paper P onto which the toner image T has been transferred to the paper receiver 42 through the fixing device 16. In the present exemplary embodiment, the sheet of recording paper P that has been transported to the transfer drum 30, which will be described below, is rotated while being wrapped around the transfer drum 30 by a leading-end gripper 32 and a trailing-end gripper 34, which will be described below. The path along which the sheet of recording paper P is transported in this manner is referred to as a rotating path 43.

The paper feed unit 18 includes the paper container 18A, a pick-up roller 18B, and a paper size sensor (not shown). The paper container 18A is disposed in a lower section of the image forming apparatus 10, more specifically, below the transfer drum 30, which is an example of a recording-medium transporting body and will be described in detail below, and contains sheets of recording paper P. The pick-up roller 18B picks up the sheets of recording paper P from the paper container 18A. The paper size sensor is provided on the pick-up roller 18B and detects the size of the sheets of recording paper P contained in the paper container 18A. The paper feed unit 18 also includes separation rollers 18C that separate the sheets of recording paper P from each other, a registration sensor 18D that is provided on the feed path 40 and used to transport the sheets of recording paper P at a set timing, and transport rollers 18E that transport the sheets of recording paper P.

A paper detection sensor 36 is disposed near the feed path 40. The paper detection sensor 36 is arranged so as to face the outer peripheral surface of the transfer drum 30 with the feed path 40 provided therebetween. The paper detection sensor 36 detects passage of each sheet of recording paper P that is transported while being wrapped around the transfer drum 30. More specifically, the paper detection sensor 36 emits near-infrared light toward the outer peripheral surface of the transfer drum 30 and receives reflected light (near-infrared light) from the outer peripheral surface of the transfer drum 30 or the sheet of recording paper P retained by the transfer drum 30. The paper detection sensor 36 detects passage of the leading and trailing ends of the sheet of recording paper P in the transporting direction by detecting a change in the intensity of the reflected light.

The paper detection sensor 36 is disposed upstream of a standby position of the trailing-end gripper 34, which will be described below, in the transporting direction of the sheet of recording paper P. In the present exemplary embodiment, for example, the paper detection sensor 36 is disposed between the standby position of the trailing-end gripper 34 and a paper feed position Pa of the sheet of recording paper P, which will be described below. The paper detection sensor 36 also measures the rotational position of the transfer drum 30 that rotates by detecting marks (not shown) formed on the outer peripheral surface of an end portion of the transfer drum 30 in the axial direction.

The fixing device 16 is provided on the output path 41 and includes, for example, a heating roller 16A and a pressing roller 16B. The heating roller 16A is rotatable and a heat source (not shown) including, for example, a halogen lamp is disposed in the heating roller 16A. The pressing roller 16B is rotatable and has an axial direction that coincides with that of the heating roller 16A. The pressing roller 16B presses the sheet of recording paper P against the outer peripheral surface of the heating roller 16A. Paper output rollers 44 are disposed downstream of the fixing device 16 in the transporting direction of the sheet of recording paper P.

The controller 20 receives signals from a user interface (not shown) that is operated by the user. The controller 20 also receives an image signal from an image output instruction unit (not shown) that is disposed inside or outside of the image forming apparatus 10. The controller 20 also receives the signal of passage of the sheet of recording paper P and a signal of phase of the photoconductor drum 22 from the paper detection sensor 36.

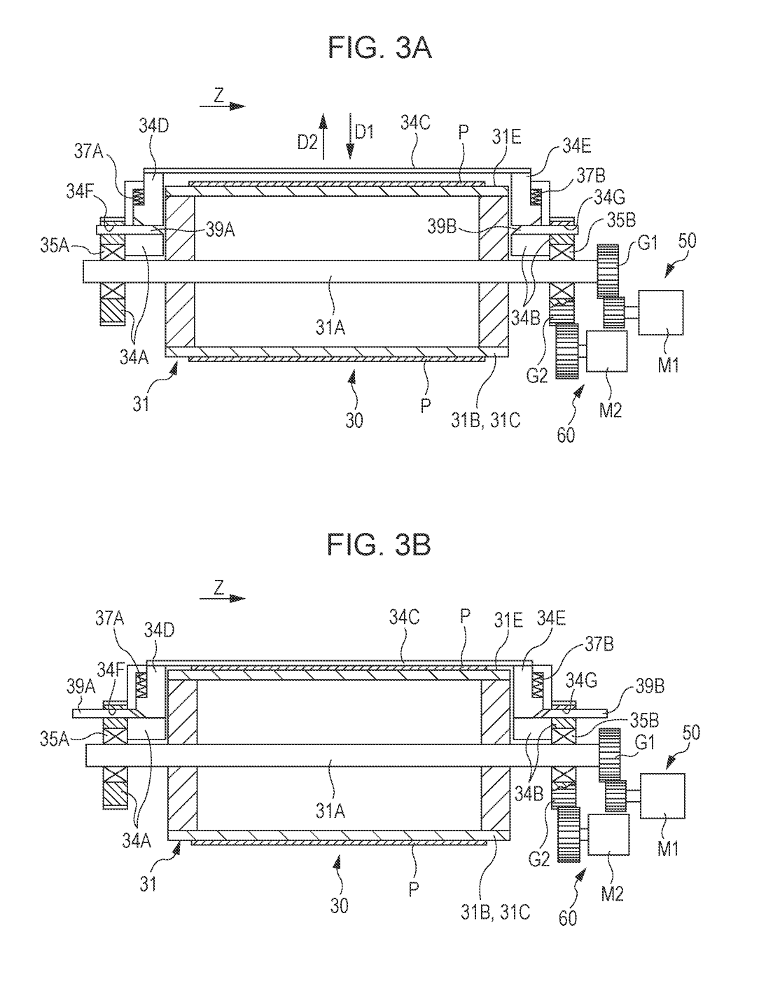

The controller 20 outputs control signals to the following parts. That is, the controller 20 outputs control signals to a photoconductor-drum driver (not shown) that rotates the photoconductor drum 22; the charging device 24; the exposure device 26; a developing-device driver (not shown) that places the desired one of the developing units 28Y, 28M, 28C, and 28K at a developing position, at which the developing device 28 faces the photoconductor drum 22, by rotating and stopping the developing device 28; a developing-bias setting unit (not shown) that sets a developing bias supplied to one of the developing units 28Y, 28M, 28C, and 28K that is placed at the developing position; a transfer-drum driver 50 described below that rotates the transfer drum 30 (see a transfer-drum motor M1 and a transfer-drum gear G1 in FIG. 3A); a trailing-end-gripper driver that rotates the trailing-end gripper 34 (see a trailing-end-gripper motor M2 and a shaft-portion gear G2 in FIG. 3A); a transfer-bias applying unit 33, which is an example of a transfer unit that sets a transfer bias to be supplied to the transfer drum 30 (bias that generates a potential difference between the transfer drum 30 and the photoconductor drum 22); the leading-end gripper 32; trailing-end gripper 34; the paper feed unit 18; and the fixing device 16.

### Structure of Relevant Part

The transfer device 14 will now be described.

Referring to FIG. 1, the transfer device 14 includes the transfer drum 30, the transfer-drum driver 50 (see FIG. 3A), which is an example of a rotating unit, and a transfer-bias applying unit 33. The transfer drum 30 is an example of a recording-medium transporting body that retains the sheet of recording paper P. The transfer-drum driver 50 rotates the transfer drum 30. The transfer-bias applying unit 33 transfers the toner image T, which is formed on the photoconductor drum 22 that faces the outer peripheral surface of the transfer drum 30, onto the sheet of recording paper P that is transported by the transfer drum 30 that is rotated by the transfer-drum driver 50. The transfer device 14 further includes the paper detection sensor 36, which detects passage of the sheet of recording paper P.

The transfer drum 30 includes a cylindrical portion 31, the leading-end gripper 32, a contact unit 100, and the trailing-end gripper 34. The sheet of recording paper P is wrapped around an outer peripheral surface 31E of the cylindrical portion 31. The leading-end gripper 32 is an example of a holding portion that holds a leading-end portion of the sheet of recording paper P. The controller 100 is disposed in a cut portion 31D formed in the outer peripheral surface 31E. The trailing-end gripper 34 retains a trailing-end portion of the sheet of recording paper P.

The outer peripheral surface 31E of the cylindrical portion 31 faces the outer peripheral surface of the photoconductor drum 22. The cylindrical portion 31 is rotatable around the rotating shaft 31A, and is detachable from the housing 10A. The cylindrical portion 31 includes a cylindrical base 31B and an elastic layer 31C that is formed on the outer peripheral surface of the base 31B. More specifically, the elastic layer 31C extends along the outer peripheral surface of the base 31B from a leading-end portion BL to a trailing-end portion BT of the elastic layer 31C in the transporting direction of the sheet of recording paper P. The cylindrical portion 31 has a cut portion 31D that is recessed in the radial direction and at which the base 31B is exposed.

The cylindrical portion 31 is configured to rotate in the direction of arrow B (counterclockwise in FIG. 1) at a peripheral speed that is slightly different from that of the photoconductor drum 22 while the elastic layer 31C is elastically deformed so as to form a nip portion between the elastic layer 31C and the photoconductor drum 22. The rotating shaft (not shown) of the photoconductor drum 22 and the rotating shaft 31A of the cylindrical portion 31 are rotatably supported by the housing 10A. The distance between the rotating shafts of the photoconductor drum 22 and the cylindrical portion 31 is maintained. For example, the outer diameter of the cylindrical portion 31 is greater than that of the photoconductor drum 22 and is 120 mm.

The base 31B of the cylindrical portion 31 is, for example, a conductive hollow tube made of a metal. The elastic layer 31C is a semiconductive elastic member and is made of rubber, such as polyurethane, chloroprene, ethylene propylene rubber (EPDM), or nitrile rubber (NBR). For example, the elastic layer 31C is made of polyurethane. The elastic layer 31C has no dielectric, such as a dielectric sheet, on the outer peripheral surface thereof. The peripheral length of the cylindrical portion 31 (the peripheral length of the elastic layer 31C) is greater than the maximum print length, that is, the maximum length of an image formed on the sheet of recording paper P by the image forming apparatus 10 in the transporting direction of the sheet of recording paper P.

The transfer-bias applying unit 33 applies a transfer bias, which is a voltage having a polarity opposite to that of the toner, to the base 31B. Accordingly, the toner image T on the photoconductor drum 22 is transferred onto the sheet of recording paper P on the elastic layer 31C in the transfer region Tr. The transfer region Tr is a region in which the photoconductor drum 22 and the transfer drum 30 face or oppose each other and in which the photoconductor drum 22 and the transfer drum 30 may be in contact with each other to transfer the toner image T on the photoconductor drum 22 onto the sheet of recording paper P on the elastic layer 31C.

The leading-end gripper 32 and the trailing-end gripper 34 are rotatable together with the transfer drum 30, and are configured to retain the sheet of recording paper P on the transfer drum 30. The leading-end gripper 32 and the trailing-end gripper 34 will now be described in detail.

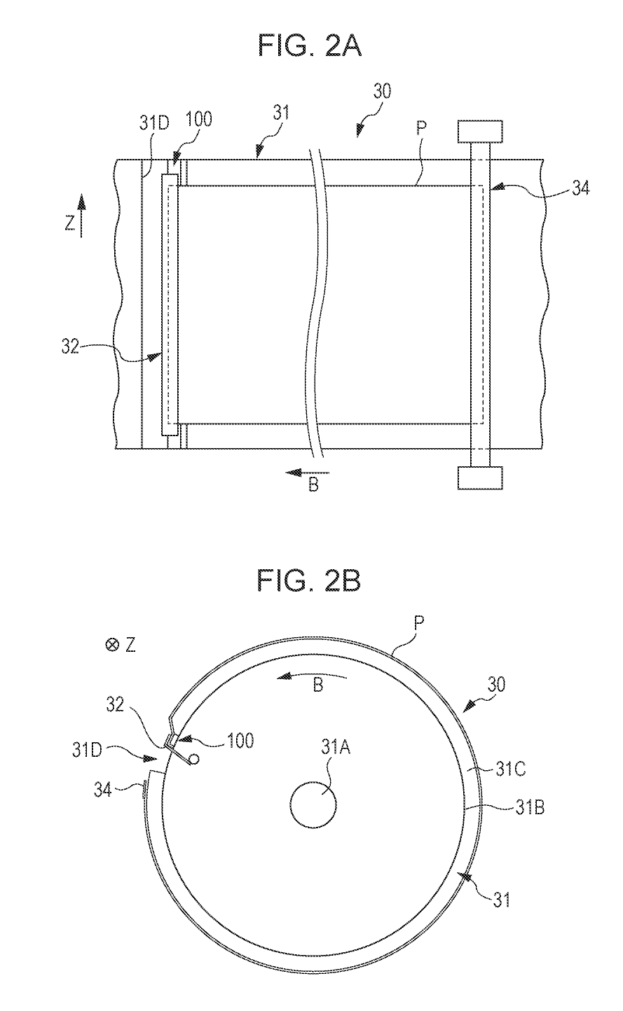

As illustrated in FIGS. 2A and 2B, the leading-end portion of the sheet of recording paper P in the transporting direction (direction of arrow B) thereof, that is, the left end portion of the sheet of recording paper P in FIG. 2A, is held by the leading-end gripper 32 on the transfer drum 30. The trailing-end portion of the sheet of recording paper P in the transporting direction thereof, that is, the right end portion of the sheet of recording paper P in FIG. 2A, is retained by the trailing-end gripper 34. The leading-end gripper 32 is fixed to the transfer drum 30.

The trailing-end gripper 34 is formed separately from the transfer drum 30 (see FIG. 1), and the position of the trailing-end gripper 34 that faces the transfer drum 30 is changeable. As described in detail below, the leading-end gripper 32 holds the sheet of recording paper P so as to restrain the sheet of recording paper P from being displaced in the transporting direction and from moving away from the transfer drum 30. The trailing-end gripper 34 retains the sheet of recording paper P so as to allow the sheet of recording paper P to be displaced in the transporting direction but restrain the sheet of recording paper P from moving away from the transfer drum 30.

### Trailing-End Gripper

The trailing-end gripper 34 will now be described.

As illustrated in FIGS. 3A and 3B, the trailing-end gripper 34 is formed in an angular U-shape so as to extend over the transfer drum 30 in the axial direction of the rotating shaft 31A of the cylindrical portion 31 (direction shown by arrow Z, hereinafter referred to as Z direction). The trailing-end gripper 34 includes disc-shaped shaft portions 34A and 34B, whose axial directions coincide with the Z direction, at both ends of the trailing-end gripper 34 in the Z direction. Bearings 35A and 35B are provided on the radially inner sides of the shaft portions 34A and 34B, respectively. The rotating shaft 31A is inserted through the bearings 35A and 35B. Therefore, the trailing-end gripper 34 is rotatable around the rotating shaft 31A independently of the transfer drum 30.

The trailing-end gripper 34 includes a rectangular paper retainer 34C and retaining portions 34D and 34E. The paper retainer 34C faces the outer peripheral surface of the transfer drum 30 and retains the sheet of recording paper P. The retaining portions 34D and 34E retain both ends of the paper retainer 34C in the Z direction and extend in the radial direction of the transfer drum 30.

The paper retainer 34C extends along the rotating shaft 31A of the transfer drum 30. The length of the paper retainer 34C is greater than the maximum width of the sheet of recording paper P that may be used in the image forming apparatus 10 (see FIG. 1), that is, the dimension of the sheet of recording paper P in the direction parallel to the rotating shaft 31A in the state in which the sheet of recording paper P is wrapped around the outer peripheral surface of transfer drum 30. The paper retainer 34C comes into contact with the photoconductor drum 22 in the transfer region Tr. Therefore, preferably, the paper retainer 34C is thin and has no corner portions.

The shape of the paper retainer 34C may be, for example, a film shape, a wire shape, or a columnar shape. The paper retainer 34C is made of a resin, such as polyethylene terephthalate (PET), polyimide, or fluorocarbon resin. Here, for example, the paper retainer 34C is made of polyimide.

The retaining portions 34D and 34E face each other with a gap therebetween, the gap being larger than the maximum width of the sheet of recording paper P that may be used in the image forming apparatus 10 (see FIG. 1). The retaining portions 34D and 34E extend in the radial direction of the transfer drum 30, and are movable in the radial direction of the transfer drum 30. The retaining portions 34D and 34E are urged toward the rotation center of the transfer drum 30 (from the outer periphery toward the inner periphery) by springs 37A and 37B that are attached to the shaft portions 34A and 34B, respectively.

Through holes 34F and 34G that extend in the Z direction are formed in the shaft portions 34A and 34B, and plate-shaped pushing members 39A and 39B are inserted through the through holes 34F and 34G, respectively.

The pushing members 39A and 39B are rotatable around the rotating shaft 31A together with the retaining portions 34D and 34E. The pushing members 39A and 39B may be moved in the Z direction by operating solenoids (not shown). The retaining portions 34D and 34E are moved in the radial direction of the transfer drum 30 when the pushing members 39A and 39B are moved in the Z direction. The retaining portions 34D and 34E and the pushing members 39A and 39B have end faces that are inclined (tapered) with respect to a horizontal or vertical plane at an angle of 45°, and are arranged such that the end faces contact each other.

As illustrated in FIG. 3A, when the pushing members 39A and 39B are moved toward the transfer drum 30 in the Z direction, the retaining portions 34D and 34E, which are respectively in contact with the pushing members 39A and 39B, are moved upward and outward in the radial direction of the cylindrical portion 31. Accordingly, the gap between the paper retainer 34C and the outer peripheral surface 31E of the cylindrical portion 31 is increased so as to form an opening.

As illustrated in FIG. 3B, when the pushing members 39A and 39B are moved away from the transfer drum 30, the retaining portions 34D and 34E are moved inward in the radial direction of the cylindrical portion 31. Accordingly, the gap between the paper retainer 34C and the outer peripheral surface 31E of the cylindrical portion 31 is reduced and the sheet of recording paper P that is wrapped around the outer peripheral surface 31E is retained.

As illustrated in FIGS. 3A and 3B, the transfer drum 30 is rotated by the transfer-drum driver 50. The transfer-drum driver 50 includes a transfer-drum motor M1 that rotates the transfer drum 30 and a transfer-drum gear G1 that is connected to an end of the rotating shaft 31A and receives a driving force from the transfer-drum motor M1.

The trailing-end gripper 34 is rotated by a trailing-end-gripper driver 60. The trailing-end-gripper driver 60 includes a trailing-end-gripper motor M2 that rotates the shaft portion 34B of the trailing-end gripper 34 and a shaft-portion gear G2 that is provided on the outer peripheral surface of the shaft portion 34B and receives a driving force from the trailing-end-gripper motor M2.

### Leading-End Gripper

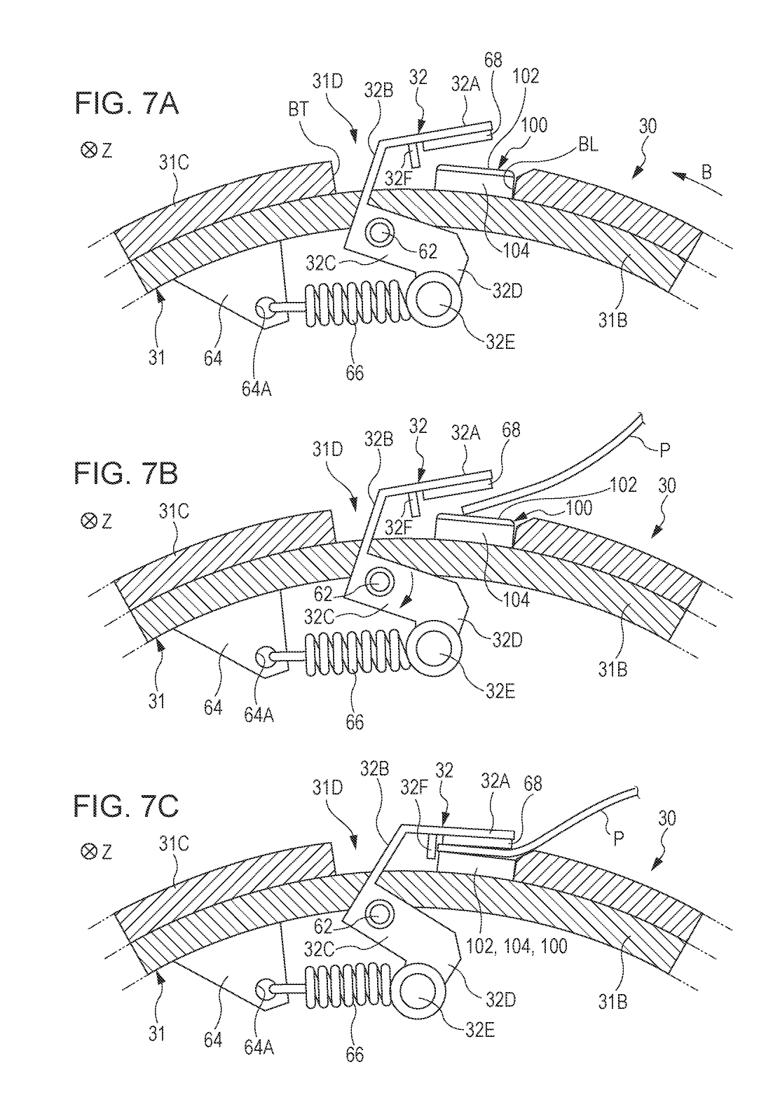

The leading-end gripper 32 will now be described. Referring to FIG. 7A, the leading-end gripper 32 is disposed in the cut portion 31D of the transfer drum 30. One end portion (connecting portion 32C described below) of the leading-end gripper 32 is connected to the cylindrical portion 31. The other end portion (distal end portion 32A described below) of the leading-end gripper 32 moves relative to the cylindrical portion 31 so as to hold the sheet of recording paper P that is inserted between the leading-end gripper 32 and the cylindrical portion 31 (contact unit 100) (see FIG. 7C).

Specifically, the leading-end gripper 32 is made of, for example, a stainless steel (SUS) and is disposed between the trailing-end portion BT and the leading-end portion BL of the elastic layer 31C. The leading-end gripper 32 is configured so as not to contact the photoconductor drum 22 (see FIG. 1) when the leading-end gripper 32 is in the closed state. In FIGS. 7A, 7B, and 7C, the leading-end gripper 32 and the contact unit 100 are enlarged to facilitate understanding of the configurations thereof. Therefore, in FIGS. 7A, 7B, and 7C, the leading-end gripper 32 extends outward beyond the elastic layer 31C.

Referring to FIG. 7A, when viewed in the axial direction of the transfer drum 30, the leading-end gripper 32 includes the distal end portion 32A which is plate-shaped and sandwiches the sheet of recording paper P between itself and the contact unit 100; an inclined portion 32B that extends obliquely from an end of the distal end portion 32A toward the inside of the cylindrical portion 31; a connecting portion 32C that is formed integrally with the inclined portion 32B at an end opposite the distal end portion 32A; and a hook portion 32D provided at an end of the connecting portion 32C opposite the inclined portion 32B.

A plate-shaped friction member 68 is bonded to a surface (bottom surface) of the distal end portion 32A that faces the contact unit 100. The friction member 68 is made of a material similar to that of second contact portions 104, which will be described below. A plate-shaped stopper portion 32F is provided on the bottom surface of the distal end portion 32A so as to project downward at a position closer to the inclined portion 32B than the friction member 68. When the leading-end gripper 32 holds the sheet of recording paper P, the leading end of the sheet of recording paper P comes into contact with the stopper portion 32F so that the movement of the sheet of recording paper P is regulated.

A columnar pin 62 that projects outward in the Z direction and a plate-shaped protruding portion 64 that protrudes toward the inside of the cylindrical portion 31 are provided at each end of the cylindrical portion 31 in the Z direction. The pin 62 is inserted through a through hole (not shown) formed in the connecting portion 32C in the Z direction, so that the leading-end gripper 32 is movable (rotatable) so as to pivot around the pin 62.

The protruding portion 64 has a through hole 64A that extends therethrough in the Z direction, and one end of a tension spring 66 is connected to the edge of the through hole 64A. The other end of the tension spring 66 is connected to a projection 32E provided on the hook portion 32D. The distal end portion 32A moves toward the contact unit 100 owing to the tension of the tension spring 66 so that the leading-end gripper 32 holds the sheet of recording paper P together with the contact unit 100, that is, so that the gap between the leading-end gripper 32 and the contact unit 100 is closed.

Although not illustrated, the hook portion 32D of the leading-end gripper 32 extends toward the inside of the cylindrical portion 31 beyond the projection 32E. A solenoid (not shown) is provided on the extending portion of the hook portion 32D at the same side as the tension spring 66. The solenoid operates so as to move the hook portion 32D in a direction such that the tension spring 66 is stretched. Thus, the state in which the leading-end gripper 32 is opened with respect to the contact unit 100 may be maintained even when the tension of the tension spring 66 is applied. The leading-end gripper 32 opens toward the downstream side in the transporting direction of the sheet of recording paper P. When the solenoid returns to the original position, the leading-end gripper 32 is closed by the tension of the tension spring 66, as described above.

### Contact Unit

The contact unit 100 will now be described.

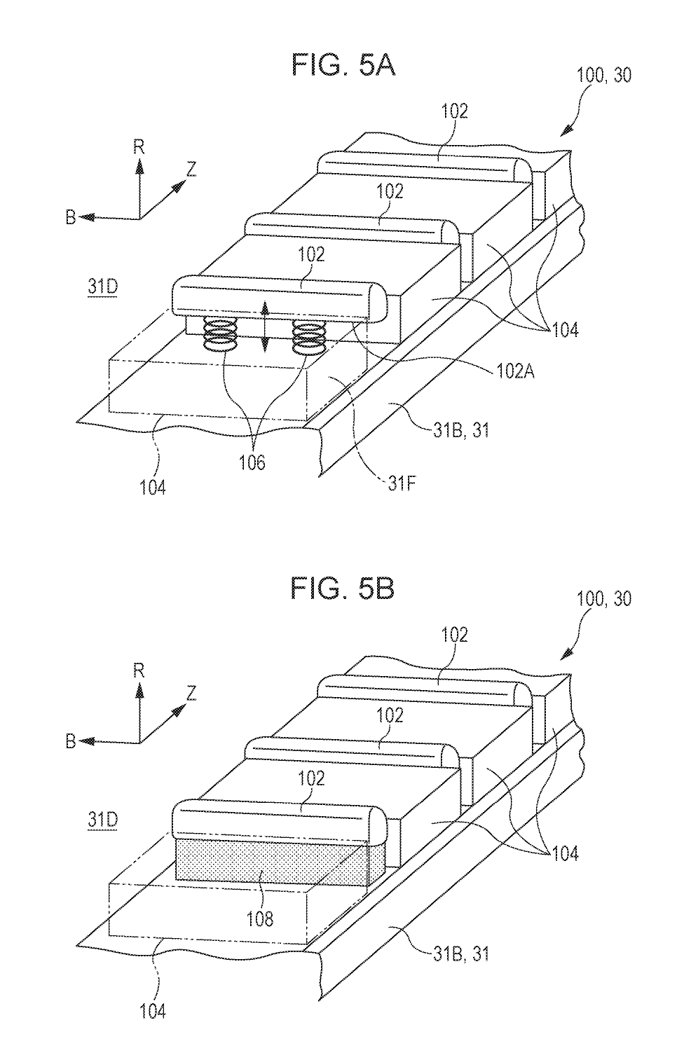

Referring to FIG. 5A, the contact unit 100 includes plural first contact portions 102 that have a first coefficient of friction μ1 (not shown) with respect to the sheet of recording paper P (see FIG. 1) and plural second contact portions 104 that have a second coefficient of friction μ2 (not shown) that is higher than the first coefficient of friction μ1. The first contact portions 102 and the second contact portions 104 are alternately arranged in a width direction (Z direction) that crosses the transporting direction of the sheet of recording paper P (B direction).

Each first contact portion 102 is shaped such that corners of a rectangular-parallelepiped-shaped block are rounded into an arc shape so as to have a curved surface. Each first contact portion 102 is made of a resin, such as polyacetal (POM resin) or nylon, or a metal, such as a stainless steel. In the present exemplary embodiment, each first contact portion 102 is made of polyacetal. A coefficient of kinetic friction of polyacetal with respect to stainless steel measured with a universal testing machine (friction tester) based on JIS K 7125 is, for example, about 0.15. Each first contact portion 102 is attached to the cylindrical portion 31 (base 31B) of the transfer drum 30 with one or more springs 106 (two springs 106 in the illustrated example), which will be described below, interposed between the first contact portion 102 and the cylindrical portion 31 (base 31B). The springs 106 are an example of a height-changing unit and an elastic body. Here, a coefficient of friction with respect to the sheet of recording paper P may instead be measured.

Each spring 106 is fixed to a top surface 31F of the base 31B at one end thereof and to a bottom surface 102A of the first contact portion 102 at the other end thereof, and is elastically deformable in the radial direction of the transfer drum 30 (hereinafter referred to as R direction). When the sheet of recording paper P is inserted between the contact unit 100 and the leading-end gripper 32 (see FIG. 7B), the first contact portions 102 project upward (outward in the R direction) from the second contact portions 104. When the sheet of recording paper P is held between the contact unit 100 and the leading-end gripper 32 (see FIG. 7C), the first contact portions 102 and the second contact portions 104 are at substantially the same height. In other words, the first contact portions 102 are configured such that the height thereof in the R direction of the cylindrical portion 31 is variable.

Each second contact portion 104 is a rectangular-parallelepiped-shaped block that has a small height in the R direction and extends in the transporting direction of the sheet of recording paper P (hereinafter referred to as B direction) and the axial direction of the transfer drum 30 (hereinafter referred to as Z direction). Each second contact portion 104 is made of a urethane rubber, a silicone rubber, or the like. In the present exemplary embodiment, each second contact portion 104 is made of a urethane rubber. A coefficient of kinetic friction of the urethane rubber with respect to stainless steel measured with a universal testing machine (friction tester) based on JIS K 7125 is, for example, about 0.75. As described above, the second coefficient of friction μ2 of the second contact portions 104 is higher than the first coefficient of friction μl of the first contact portions 102. The second contact portions 104 are fixed to the base 31B in the cut portion 31D of the transfer drum 30. Also when the coefficient of friction with respect to the sheet of recording paper P is measured, the second coefficient of friction μ2 is higher than the first coefficient of friction μ1.

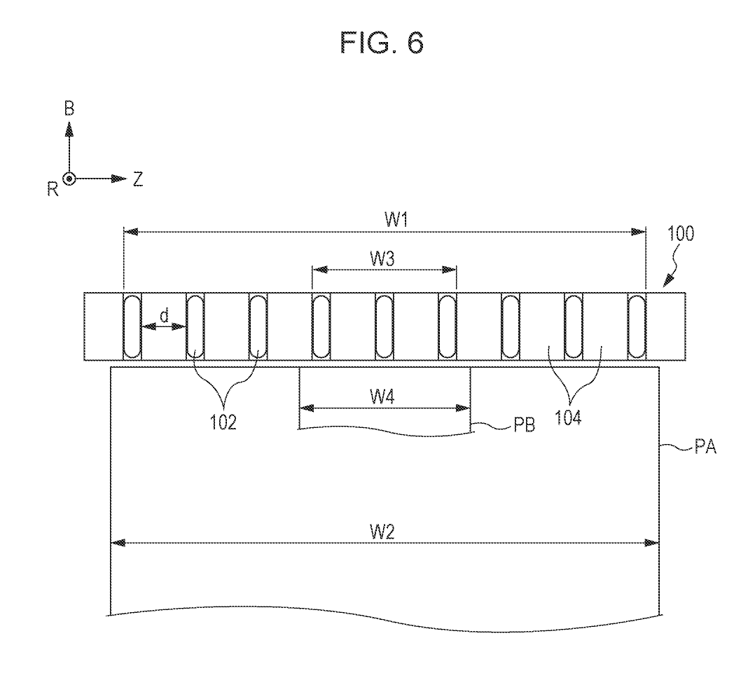

Referring to FIG. 6, in a plan view of the contact unit 100 viewed in the R direction, nine first contact portions 102, for example, are provided. The distance (width) between the upstream-side (left side in FIG. 6) surface of the first contact portion 102 at the most upstream position in the Z direction and the downstream-side (right side in FIG. 6) surface of the first contact portion 102 at the most downstream position in the Z direction is W1. A width W2 of a sheet of recording paper PA (for example, a sheet of horizontally oriented A4-size normal paper) in the Z direction is greater than W1. Therefore, when the sheet of recording paper PA is transported such that the center thereof in the Z direction is aligned with the center of the contact unit 100 in the Z direction, the ends of the sheet of recording paper PA in the Z direction are positioned outside the first contact portions 102 and on the second contact portions 104.

Similarly, with regard to the three first contact portions 102 disposed in the central area of the contact unit 100, the distance (width) between the upstream-side (left side in FIG. 6) surface of the first contact portion 102 at the most upstream position in the Z direction and the downstream-side (right side in FIG. 6) surface of the first contact portion 102 at the most downstream position in the Z direction is W3. A width W4 of a sheet of recording paper PB (for example, a postcard) in the Z direction is greater than W3. Therefore, when the sheet of recording paper PB is transported such that the center thereof in the Z direction is aligned with the center of the contact unit 100 in the Z direction, the ends of the sheet of recording paper PB in the Z direction are positioned outside the first contact portions 102 and on the second contact portions 104.

In other words, when the arrangement pitch of the first contact portions 102 in the Z direction is d, (W2-W1)<d and (W4-W3)<d are satisfied. Here, preferably, (W2-W1)/2<d and (W4-W3)/2<d are satisfied.

### Image Forming Operation Performed by Image Forming Apparatus 10

An image forming operation performed by the image forming apparatus 10 (see FIG. 1) will now be described. As an example, a case will be described in which the image forming apparatus 10 forms a multicolor image on a single sheet of recording paper P.

In the image forming apparatus 10 illustrated in FIG. 1, a color reflected light image of a document read by a document reading device (not shown) or color image data generated by a personal computer (not shown) is input to an image signal processor (not shown) as, for example, red (R), green (G), and blue (B) image data and is subjected to predetermined image processing. The image data that has been subjected to image processing is converted into color gradation data of four colors, which are yellow (Y), magenta (M), cyan (C), and black (K), and is output to the exposure device 26.

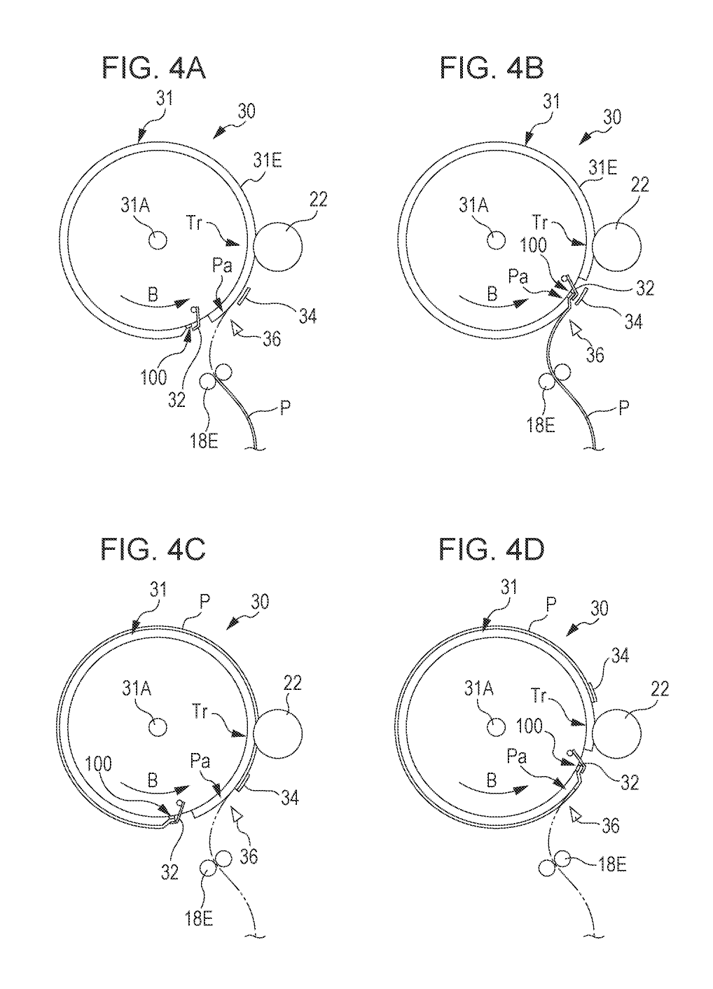

When the image forming operation is started, the photoconductor drum 22 and the transfer drum 30 rotate in synchronization with each other. At this time, the leading-end gripper 32 and the trailing-end gripper 34 are both in the open state. The leading-end gripper 32 rotates together with the transfer drum 30. The trailing-end gripper 34 is stationary at the standby position and does not rotate together with the transfer drum 30. In other words, the peripheral speed of the trailing-end gripper 34 is zero. More specifically, referring to FIG. 4A, the trailing-end gripper 34 is arranged so as to face the outer peripheral surface of the transfer drum 30 at a position between the paper feed position Pa and the transfer region Tr.

Next, referring to FIG. 1, the photosensitive layer 22A of the photoconductor drum 22 that rotates is charged by the charging device 24, and the exposure device 26 irradiates the photoconductor drum 22 with light so that an electrostatic latent image of the first color (for example, yellow) that corresponds to the image information is formed. When the transfer drum 30 starts to rotate, the paper detection sensor 36 starts measuring the rotational phase of the transfer drum 30. The measured rotational phase is transmitted to the controller 20.

In the developing device 28, the developing unit containing color toner that corresponds to the electrostatic latent image formed on the photoconductor drum 22 (the yellow developing unit 28Y when the first color is yellow) is moved to and stopped at the position at which the developing unit faces the photoconductor drum 22 in advance. The developing unit 28Y develops the electrostatic latent image on the photoconductor drum 22, so that the toner image T is formed on the photoconductor drum 22. The toner image T (yellow toner image in this case) is transported to the transfer region Tr, in which the photoconductor drum 22 faces the transfer device 14, as the photoconductor drum 22 rotates.

When the image forming operation is started, feeding of the sheet of recording paper P is also started. More specifically, the sheet of recording paper P is picked up from the paper container 18A by the pick-up roller 18B, and is transported along the feed path 40 through the separation rollers 18C by the transport rollers 18E. When the paper detection sensor 36 detects passage of the leading end of the sheet of recording paper P in the transporting direction, the paper detection sensor 36 outputs a detection signal to the controller 20. Upon receiving the detection signal, the controller 20 controls, on the basis of the detection signal and phase obtained by the paper detection sensor 36, the transportation of the sheet of recording paper P so that the sheet of recording paper P reaches the paper feed position Pa at the time when the leading-end gripper 32 reaches the paper feed position Pa.

Then, as illustrated in FIG. 4B, the state of the leading-end gripper 32 is changed from the open state to the closed state at the paper feed position Pa. As a result, the leading end portion of the sheet of recording paper P in the transporting direction is held by the leading-end gripper 32. The manner in which the sheet of recording paper P is held by the leading-end gripper 32 will be described in more detail below. At this time, the trailing-end gripper 34 is arranged so as to face the outer peripheral surface of the transfer drum 30 and is stationary at the standby position. The leading-end gripper 32 that holds the sheet of recording paper P passes through the space between the trailing-end gripper 34 in the stationary state and the rotating shaft 31A of the transfer drum 30.

After passing through the space between the trailing-end gripper 34 and the rotating shaft 31A, the leading-end gripper 32 passes through the transfer region Tr while holding the sheet of recording paper P. The sheet of recording paper P that has passed through the transfer region Tr is transported along the rotating path 43 (see FIG. 1) while being held by the leading-end gripper 32 and wrapped around the outer peripheral surface 31E of the transfer drum 30.

Subsequently, referring to FIG. 1, the paper detection sensor 36 detects passage of the trailing end of the sheet of recording paper P in the transporting direction after the electrostatic latent image of the first color (for example, yellow) that corresponds to the image information is formed on the photoconductor drum 22 by the exposure device 26. The paper detection sensor 36 transmits a detection signal to the controller 20, which then transmits an instruction to the trailing-end gripper 34 (more specifically, to a solenoid (not shown)). Upon receiving the instruction, the trailing-end gripper 34 changes the state thereof from the open state to the closed state (see arrow D1 in FIG. 3A).

Then, as illustrated in FIG. 4C, the trailing-end gripper 34 in the closed state starts to rotate in synchronization with the transfer drum 30. In other words, the sheet of recording paper P rotates together with the transfer drum 30 while the leading end portion thereof in the transporting direction is held by the leading-end gripper 32 and the trailing end portion thereof in the transporting direction is retained by the trailing-end gripper 34. The toner image of the first color (for example, yellow) formed on the photoconductor drum 22 is transferred onto the sheet of recording paper P on the transfer drum 30 in the transfer region Tr in which the photoconductor drum 22 and the transfer drum 30 face each other. The toner that remains on the photoconductor drum 22 after the transfer process is removed by the cleaning device 46 (see FIG. 1).

Subsequently, the latent-image forming process, the developing process, and the transfer process for the second color to the second-from-last color (for example, for magenta and cyan in that order) are performed in accordance with the above-described sequence. In the process of forming the toner image T of each color, the developing device 28 (see FIG. 1) is rotated so as to move the corresponding developing unit 28M or 28C (see FIG. 1) to the stop position. Meanwhile, as illustrated in FIG. 4D, the sheet of recording paper P is rotated and transported while being wrapped around the transfer drum 30 by the leading-end gripper 32 and the trailing-end gripper 34. Each time the sheet of recording paper P passes through the transfer region Tr, the toner image of one of the second and the following colors is transferred onto the sheet of recording paper P in a superimposed manner. As a result, the toner images of colors other than black (K), that is, yellow (Y), magenta (M), and cyan (C) toner images, are transferred onto the sheet of recording paper P on the transfer drum 30 in a superimposed manner.

When the toner image T of the last color (for example, black) is transferred, unlike the process of transferring the toner images of the other colors, the state of the leading-end gripper 32 is changed from the closed state to the open state after the sheet of recording paper P has passed through the transfer region Tr. Accordingly, the sheet of recording paper P is released from the leading-end gripper 32. Then, referring to FIG. 1, the leading end of the sheet of recording paper P, on which a color image has been formed, in the transporting direction is separated from the transfer drum 30 and is guided into the output path 41 from a paper release position Pb.

Subsequently, as the sheet of recording paper P is further transported, the trailing-end gripper 34, which retains the trailing end of the sheet of recording paper P in the transporting direction, changes the state thereof from the closed state to the open state (see arrow D2 in FIG. 3A). The trailing-end gripper 34 changes the state thereof from the closed state to the open state while or after the electrostatic latent image of the last color (for example, black) that corresponds to the image information is formed by the exposure device 26. The trailing-end gripper 34 in the open state stops at the standby position.

Subsequently, the trailing end of the sheet of recording paper P in the transporting direction, which has been released from the trailing-end gripper 34, is separated from the transfer drum 30 and is guided into the output path 41 from the paper release position Pb. The sheet of recording paper P that has been guided into the output path 41 is transported to the fixing device 16, where the toner images T are fixed by the heating roller 16A and the pressing roller 16B. After the fixing process, the sheet of recording paper P is discharged to the outside of the image forming apparatus 10 by the paper output rollers 44 and is placed on the paper receiver 42.

### Operation

Next, the operation of the first exemplary embodiment will be described.

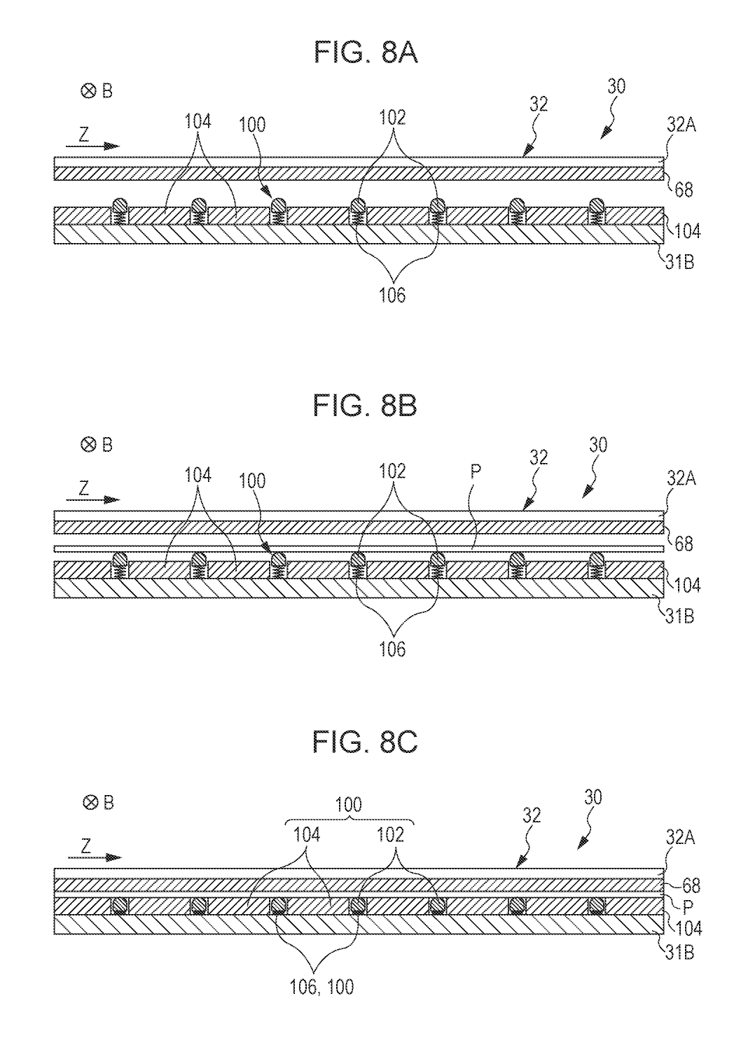

As illustrated in FIGS. 7A and 8A, when the sheet of recording paper P is not yet inserted, the leading-end gripper 32 is restrained from moving toward the contact unit 100 by a movement restraining member (not shown), so that a gap is formed between the leading-end gripper 32 and the contact unit 100. The length of the springs 106 is the natural length and the first contact portions 102 project upward (toward the leading-end gripper 32) from the top surfaces of the second contact portions 104.

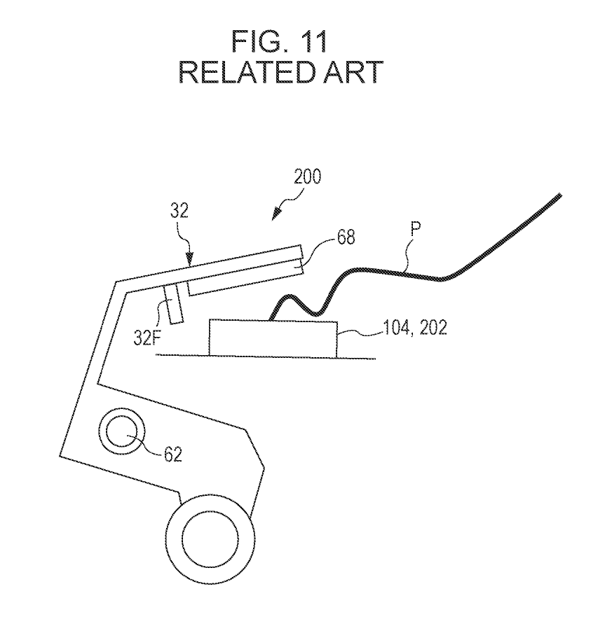

FIG. 11 illustrates a transfer drum 200 according to a comparative example. The transfer drum 200 differs from the transfer drum 30 according to the present exemplary embodiment in that a contact unit 202 is provided instead of the contact unit 100. The entirety of the contact unit 202 is made of the same material as that of the second contact portions 104.

In the transfer drum 200 according to the comparative example, when the leading end of the sheet of recording paper P is inserted between the leading-end gripper 32 and the contact unit 202, the leading end of the sheet of recording paper P comes into contact with the contact unit 202, which has a high coefficient of friction. Therefore, there is a risk that the movement of the leading end of the sheet of recording paper P will be influenced by the frictional force and the sheet of recording paper P will be held in an inappropriate manner, such as an inclined manner, in the initial state. In such a case, the sheet of recording paper P will be bent or wrinkled.

Although not illustrated, another comparative example will be considered in which both the leading-end gripper and the contact unit are made of the same material as that of the first contact portions 102. In such a case, the frictional force applied to the sheet of recording paper P after the sheet of recording paper P is held by the leading-end gripper and the contact unit is low, and there is a risk that the sheet of recording paper P will be displaced and cannot be held in an appropriate manner.

In contrast, as illustrated in FIGS. 7B and 8B, in the transfer drum 30 according to the present exemplary embodiment, the first contact portions 102 are positioned higher than the second contact portions 104 when the leading end of the sheet of recording paper P is inserted between the leading-end gripper 32 and the contact unit 100. Therefore, the leading end of the sheet of recording paper P comes into contact with the first contact portions 102 before coming into contact with the second contact portions 104. The leading end of the sheet of recording paper P is moved along the first contact portions 102, which have a low coefficient of friction, so that the sheet of recording paper P may be moved without being caught and prevented from being held in an inappropriate manner in the initial stage.

Subsequently, as illustrated in FIGS. 7C and 8C, the movement restraining member (not shown) moves to a retracted position immediately before the leading end of the sheet of recording paper P comes into contact with the stopper portion 32F. Accordingly, the distal end portion 32A of the leading-end gripper 32 is moved toward the contact unit 100 by the tension of the tension spring 66. As a result, the friction member 68 comes into contact with the sheet of recording paper P and pushes the sheet of recording paper P against the contact unit 100. At this time, the springs 106 are compressed by the pushing force of the friction member 68 and the first contact portions 102 are moved downward. Thus, the sheet of recording paper P is sandwiched by the friction member 68 (the leading-end gripper 32) and the contact unit 100 including the first and second contact portions 102 and 104 in a state such that the top surfaces of the first and second contact portions 102 and 104 are aligned with each other.

While the sheet of recording paper P is being held by the leading-end gripper 32 and the contact unit 100, the sheet of recording paper P is in contact with the second contact portions 104, which have a coefficient of friction that is higher than that of the first contact portions 102. Therefore, the sheet of recording paper P is restrained from moving in the direction in which the sheet of recording paper P is pulled out. Thus, the state in which the sheet of recording paper P is held is maintained (prevented from being changed to a state in which the sheet of recording paper P is held in an inappropriate manner). In particular, since the end portions of the sheet of recording paper P in the Z direction are in contact with the second contact portions 104 in the present exemplary embodiment, the state in which the sheet of recording paper P is held is reliably maintained and the sheet of recording paper P may be reliably prevented from being held in an inappropriate manner.

In addition, in the transfer drum 30, the first contact portions 102 and the second contact portions 104 are alternately arranged in the Z direction. Therefore, unlike the case in which the first contact portions 102 are non-uniformly distributed in the Z direction, the sheet of recording paper P receives a frictional force that is uniform in the Z direction. Accordingly, the sheet of recording paper P may be prevented from being caught held in an inappropriate manner.

In addition, in the transfer drum 30, the height of the first contact portions 102 is variable owing to the springs 106, and the top surfaces of the first and second contact portions 102 and 104 may be aligned with each other. Therefore, the sheet of recording paper P may be held in a flat state (in a stable state) and the risk of deformation of the sheet of recording paper P may be reduced. Thus, the position at which the sheet of recording paper P is held may be stabilized.

In addition, in the transfer drum 30, the height of the first contact portions 102 is changed by the springs 106. Therefore, it is not necessary to provide a driving mechanism for changing the height of the first contact portions 102, and the height of the first contact portions 102 may be changed with a simple structure.

Referring to FIG. 1, in the image forming apparatus 10 and the transfer device 14, the sheet of recording paper P is transported and subjected to the transferring and fixing processes while displacement thereof is suppressed. Therefore, misregistration of the toner image T from the intended image forming position on the sheet of recording paper P may be suppressed. In addition, in the case where a color image is formed, color misregistration between a toner image and a toner image of another color that are superimposed on the sheet of recording paper P may be suppressed.

### Second Exemplary Embodiment

A recording-medium transporting body, a transfer device, and an image forming apparatus according to a second exemplary embodiment of the present invention will now be described. Components and parts that are basically the same as those in the above-described first exemplary embodiment are denoted by the same reference numerals as those in the first exemplary embodiment, and explanations thereof are thus omitted.

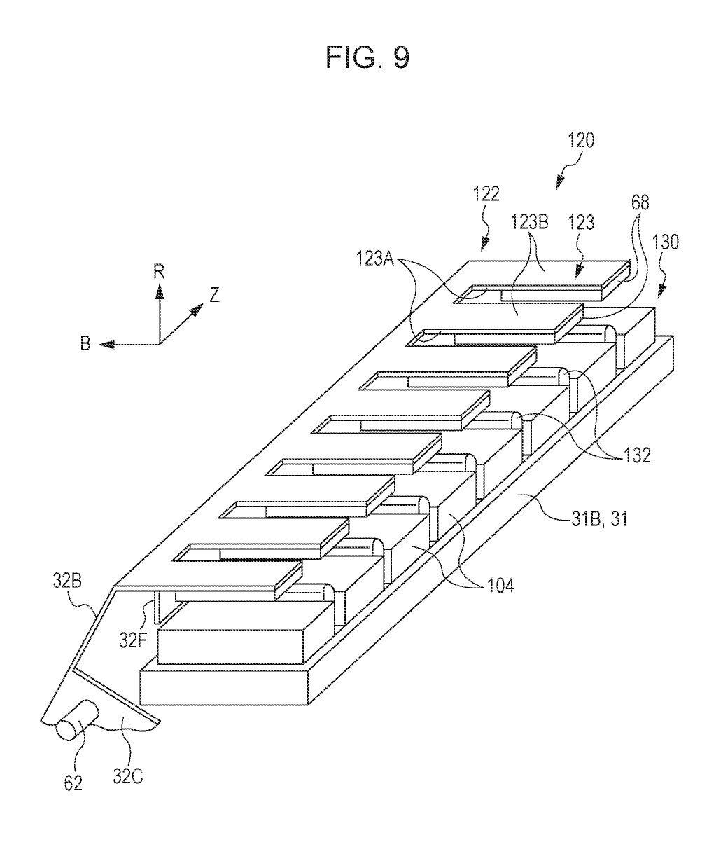

FIG. 9 illustrates a transfer drum 120 according to the second exemplary embodiment. The transfer drum 120 differs from the above-described transfer drum 30 (see FIG. 2B) in that a leading-end gripper 122, which is an example of a holding portion, is provided in place of the leading-end gripper 32 and a contact unit 130 is provided in place of the contact unit 100. Parts other than the leading-end gripper 122 and the contact unit 130 are similar to those of the transfer drum 30, and explanations thereof are thus omitted.

### Leading-End Gripper

The leading-end gripper 122 will now be described.

As illustrated in FIG. 9, the leading-end gripper 122 differs from the leading-end gripper 32 (see FIG. 7A) according to the first exemplary embodiment in that a distal end portion 123 is provided in place of the distal end portion 32A. The other structures of the leading-end gripper 122 are similar to those of the leading-end gripper 32. The leading-end gripper 122 is made of, for example, a stainless steel (SUS). The leading-end gripper 122 is configured so as not to contact the photoconductor drum 22 (see FIG. 1) when the leading-end gripper 122 is in the closed state.

The distal end portion 123 is a plate-shaped member whose longitudinal direction is in the Z direction, and is provided with plural slit portions 123A that open at the side from which the sheet of recording paper P (not shown in FIG. 9) is inserted. The slit portions 123A are arranged with spaces therebetween in the Z direction. Portions between the slit portions 123A are formed as plate-shaped portions 123B. Friction members 68 are bonded to the bottom surfaces of the plate-shaped portions 123B. The stopper portion 32F is provided on the bottom surface of the distal end portion 123 so as to project downward at a position closer to the inclined portion 32B than the friction members 68.

The slit portions 123A are formed such that the size and arrangement thereof correspond to those of first contact portions 132, which will be described below. Accordingly, when the leading-end gripper 122 comes into contact with the contact unit 130, the first contact portions 132 are disposed in the slit portions 123A and do not come into contact with the friction members 68 on the plate-shaped portions 123B. In FIG. 9, the leading-end gripper 122 is shifted in the R direction to facilitate understanding of the configurations of the leading-end gripper 122 and the contact unit 130.

Columnar movement restraining members (not shown) that project and retract in the Z direction in response to an operation of a solenoid (not shown) are provided in regions outside the leading-end gripper 122 in the Z direction. The movement restraining members project in the Z direction and come into contact with the bottom surface of the distal end portion 123 of the leading-end gripper 122, so that the state in which the leading-end gripper 122 is opened with respect to the contact unit 130 may be maintained even when the tension of the tension spring 66 (see FIG. 7A) is applied. The leading-end gripper 122 opens toward the downstream side in the transporting direction of the sheet of recording paper P. When the movement restraining members are moved to the retracted position, the leading-end gripper 122 is closed by the tension of the tension spring 66, as described above.

### Contact Unit

The contact unit 130 will now be described.

Referring to FIG. 9, the contact unit 130 includes plural first contact portions 132 that have a first coefficient of friction μ1 (not shown) with respect to the sheet of recording paper P (see FIG. 1) and the second contact portions 104. The first contact portions 132 and the second contact portions 104 are alternately arranged in the Z direction.

Each first contact portion 132 is shaped such that corners of a rectangular-parallelepiped-shaped block are cut into an arc shape so as to have a curved surface. Each first contact portion 132 is made of polyacetal (POM resin), nylon, or a metal, such as a stainless steel. In the present exemplary embodiment, each first contact portion 132 is made of polyacetal. The height of the first contact portions 132 in the R direction is greater than that of the second contact portions 104, and the first contact portions 132 are directly attached to the cylindrical portion 31 (the base 31B) of the transfer drum 120.

Thus, in the transfer drum 120, the amount by which the first contact portions 132 project in the R direction is larger than the amount by which the second contact portions 104 project in the R direction. The leading-end gripper 122 holds the sheet of recording paper P between the leading-end gripper 122 and the second contact portions 104 in areas excluding the first contact portions 132. The arrangement of the first contact portions 132 in the Z direction is similar to the arrangement of the first contact portions 102 (see FIG. 6) in the first exemplary embodiment, and explanations thereof are thus omitted.

### Operation

Next, the operation of the second exemplary embodiment will be described.

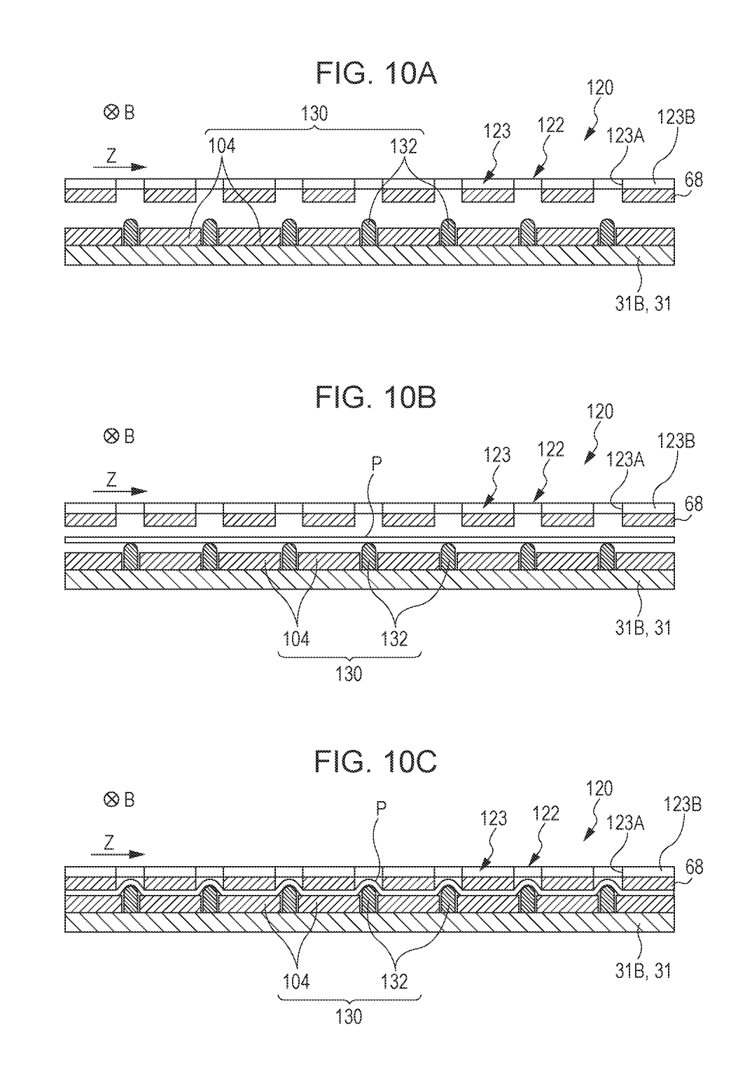

As illustrated in FIG. 10A, when the sheet of recording paper P is not yet inserted, the leading-end gripper 122 is restrained from moving toward the contact unit 130 by the movement restraining members (not shown), so that a gap is formed between the leading-end gripper 122 and the contact unit 130. The first contact portions 132 project upward (toward the leading-end gripper 122) from the top surfaces of the second contact portions 104.

As illustrated in FIG. 10B, the first contact portions 132 are positioned higher than the second contact portions 104 when the leading end of the sheet of recording paper P is inserted between the leading-end gripper 122 and the contact unit 130. Therefore, the leading end of the sheet of recording paper P comes into contact with the first contact portions 132 before coming into contact with the second contact portions 104. The leading end of the sheet of recording paper P is moved along the first contact portions 132, which have a lower coefficient of friction than that of the second contact portions 104, so that the sheet of recording paper P may be moved without being caught and prevented from being held in an inappropriate manner in the initial stage.

Subsequently, as illustrated in FIG. 10C, the movement restraining members (not shown) move to the retracted position immediately before the leading end of the sheet of recording paper P comes into contact with the stopper portion 32F (see FIG. 9). Accordingly, the distal end portion 123 of the leading-end gripper 122 is moved toward the contact unit 130 by the tension of the tension spring 66 (see FIG. 7A). As a result, the friction member 68 comes into contact with the sheet of recording paper P and pushes the sheet of recording paper P against second contact portions 104. Thus, the sheet of recording paper P is sandwiched between the friction members 68 (the leading-end gripper 122) and the second contact portions 104 (the contact unit 130).

At this time, top end portions of the first contact portions 132 are received by the slit portions 123A (and the spaces between the friction members 68), so that parts of the sheet of recording paper P that are positioned on the first contact portions 132 are not pressed against the first contact portions 132 by the leading-end gripper 122. In FIG. 10C, to facilitate understanding of the arrangement of the first contact portions 132, the first contact portions 132 are illustrated such that the first contact portions 132 project by a large amount and the sheet of recording paper P have projections and recesses. However, in practice, the amount of projection of the first contact portions 132 is not so large as to form projections and recesses on the sheet of recording paper P and is, for example, 0.5 mm.

While the sheet of recording paper P is being held by the leading-end gripper 122 and the contact unit 130, the sheet of recording paper P is in contact with the second contact portions 104, which have a coefficient of friction that is higher than that of the first contact portions 132. Therefore, the sheet of recording paper P is restrained from moving. Thus, the state in which the sheet of recording paper P is held is maintained. In particular, since the end portions of the sheet of recording paper P in the Z direction are in contact with the second contact portions 104 in the present exemplary embodiment, the state in which the sheet of recording paper P is held is reliably maintained (displacement of the sheet of recording paper P is suppressed) and the sheet of recording paper P is reliably prevented from being held in an inappropriate manner.

In addition, in the transfer drum 120, the first contact portions 132 and the second contact portions 104 are alternately arranged in the Z direction. Therefore, unlike the case in which the first contact portions 132 are non-uniformly distributed in the Z direction, the sheet of recording paper P receives a frictional force that is uniform in the Z direction. Accordingly, the sheet of recording paper P may be more reliably moved without being caught when the sheet of recording paper P is held.

Referring to FIG. 1, in the image forming apparatus 10 and the transfer device 14, the sheet of recording paper P is transported and subjected to the transferring and fixing processes while displacement thereof is suppressed. Therefore, misregistration of the toner image T from the intended image forming position on the sheet of recording paper P may be suppressed. In addition, in the case where a color image is formed, color misregistration between a toner image and a toner image of another color that are superimposed on the sheet of recording paper P may be suppressed.

The present invention is not limited to the above-described exemplary embodiments.

As illustrated in FIG. 5B, as another example of the height-changing unit, a rectangular-parallelepiped-shaped elastic body 108 may be used instead of the springs 106 (see FIG. 5A). The elastic body 108 may be made of, for example, a polyurethane sponge.

The height-changing unit is not limited to an elastic body, and may instead be, for example, a raising-and-lowering mechanism including an actuator or an eccentric cam.

Although the height of the first contact portions 102 is variable (the first contact portions 102 are movable) in the first exemplary embodiment, the second contact portions 104 may instead be configured such that the height thereof is variable. For example, in the transfer drum 30 according to the first exemplary embodiment, the first contact portions 132 according to the second exemplary embodiment that are fixed to the base 31B may be used instead of the first contact portions 102, and a height-changing unit including an actuator may be provided between the bottom surface of each second contact portion 104 and the base 31B. In such a case, when the sheet of recording paper P is sandwiched between the leading-end gripper 32 and the contact unit 100, the second contact portions 104 are moved upward so that the top surfaces of the first and second contact portions 102 and 104 are aligned with each other. When the leading-end gripper 32 is opened, the second contact portions 104 are moved downward so that the first contact portions 102 are at positions higher than the second contact portions 104.

Alternatively, a contact unit including a first contact portion 102 on a front surface thereof and a second contact portion 104 on a back surface thereof may be used. In such a case, the contact unit is arranged such that the first contact portion 102 faces upward when the sheet of recording paper P is inserted and is rotated so that the second contact portion 104 faces upward when the sheet of recording paper P is held.

The recording-medium transporting body is not limited to the transfer drums 30 and 120, and may instead be a transport roller that is used simply to transport the sheet of recording paper P. In addition, the image forming apparatus is not limited to an electrophotographic image forming apparatus, and may instead be an apparatus that uses other image forming methods, such as an inkjet image forming method.

In addition, the risk that the sheet of recording paper P will be held in an appropriate manner may be reduced even when the transfer drum 30 is not provided with the friction member 68.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording-medium transporting body comprising:
a cylindrical portion that has a cut portion in an outer peripheral surface thereof and allows a recording medium to be wrapped around the outer peripheral surface;
a contact unit that is provided in the cut portion and includes a first contact portion having a first coefficient of friction with respect to the recording medium and a second contact portion having a second coefficient of friction with respect to the recording medium, the second coefficient of friction being higher than the first coefficient of friction, and a leading end of the recording medium coming into contact with the first contact portion before coming into contact with the second contact portion; and
a holding portion that holds the recording medium between the contact unit and the holding portion.

2. The recording-medium transporting body according to claim 1,
wherein the first and second contact portions are alternately arranged in a width direction that crosses a direction in which the recording medium is transported.

3. The recording-medium transporting body according to claim 1, further comprising:
a height changing unit provided between the cylindrical portion and one of the first and second contact portions, the height changing unit changing a height of the one of the first and second contact portions in a radial direction of the cylindrical portion between a height for when the recording medium is being inserted between the contact unit and the holding portion and a height for when the recording medium is held between the contact unit and the holding portion.

4. The recording-medium transporting body according to claim 2, further comprising:
a height changing unit provided between the cylindrical portion and one of the first and second contact portions, the height changing unit changing a height of the one of the first and second contact portions in a radial direction of the cylindrical portion between a height for when the recording medium is being inserted between the contact unit and the holding portion and a height for when the recording medium is held between the contact unit and the holding portion.

5. The recording-medium transporting body according to claim 3,
wherein the height changing unit causes the first contact portion to be higher than the second contact portion toward the outer side in the radial direction when the recording medium is being inserted between the contact unit and the holding portion and lower than the second contact portion toward the inner side in the radial direction when the recording medium is held between the contact unit and the holding portion.

6. The recording-medium transporting body according to claim 4,
wherein the height changing unit causes the first contact portion to be higher than the second contact portion toward the outer side in the radial direction when the recording medium is being inserted between the contact unit and the holding portion and lower than the second contact portion toward the inner side in the radial direction when the recording medium is held between the contact unit and the holding portion.

7. The recording-medium transporting body according to claim 5,
wherein the height changing unit includes an elastic body that lowers the first contact portion toward the inner side in the radial direction in association with a holding operation of the holding portion.

8. The recording-medium transporting body according to claim 6,
wherein the height changing unit includes an elastic body that lowers the first contact portion toward the inner side in the radial direction in association with a holding operation of the holding portion.

9. The recording-medium transporting body according to claim 1,
wherein an amount of projection of the first contact portion in a radial direction of the cylindrical portion is larger than an amount of projection of the second contact portion in the radial direction, and
wherein the holding portion holds the recording medium between the second contact portion and the holding portion in an area excluding the first contact portion.

10. The recording-medium transporting body according to claim 2,
wherein an amount of projection of the first contact portion in a radial direction of the cylindrical portion is larger than an amount of projection of the second contact portion in the radial direction, and
wherein the holding portion holds the recording medium between the second contact portion and the holding portion in an area excluding the first contact portion.

11. A transfer device comprising:
the recording-medium transporting body according to claim 1;
a rotating unit that rotates the recording-medium transporting body; and
a transfer unit that transfers a developer image on an image carrier, which faces the outer peripheral surface of the recording-medium transporting body, onto the recording medium that is held between the contact unit and the holding portion and transported by the recording-medium transporting body that is rotated by the rotating unit.

12. An image forming apparatus comprising:
an image carrier;
a developer-image forming unit that forms a developer image on the image carrier; and
the transfer device according to claim 11, the transfer device transferring the developer image on the image carrier onto the recording medium.

13. An image forming apparatus comprising:
an image carrier;
a developer-image forming unit that forms developer images on the image carrier; and
the transfer device according to claim 11, the transfer device transferring the developer images on the image carrier onto the recording medium in a superimposed manner by rotating the recording-medium transporting body a plurality of times.
